(19) United States
(12) Patent Application Publication
(10) Pub. No.: US 2021/0326862 A1
(43) Pub. Date: Oct. 21, 2021

(54) UNIQUE ITEM CREATION USING A DISTRIBUTED LEDGER

(71) Applicant: VERONA HOLDINGS SEZC, George Town (KY)

(72) Inventors: Jonathan YANTIS, Grants Pass, OR (US); William QUIGLEY, Pacific Palisades, CA (US); Lukasz Jakub SLIWKA, Long Beach, CA (US)

(73) Assignee: VERONA HOLDINGS SEZC, George Town (KY)

(21) Appl. No.: 17/326,583

(22) Filed: May 21, 2021

Related U.S. Application Data
(63) Continuation of application No. PCT/US2019/062673, filed on Nov. 21, 2019.
Application No. PCT/US2019/062673 is a continuation-in-part of application No. PCT/US2019/059389, filed on Nov. 1, 2019.
(60) Provisional application No. 62/770,624, filed on Nov. 21, 2018.
(60) Provisional application No. 62/770,620, filed on Nov. 21, 2018.

(51) Int. Cl. G06Q 20/38; G06Q 20/40; G06Q 20/08

(52) U.S. Cl. CPC G06Q 20/389; G06Q 20/0855; G06Q 20/401

(57) ABSTRACT

A method and apparatus for managing digital items may be implemented using a distributed ledger and smart contracts associated therewith. Users may interact with a smart contract to generate, manage ownership and transfer digital items of various kinds. The digital items are defined by characteristics particular to each implementation of the system. Some values for the characteristics may be less likely to occur relative to other values for those characteristics, thus generating some rare digital items and more common digital items. Digital items may correspond to a real-world item or may only exist virtually. A smart contract may also be used to convert the digital items to real-world physical items.

### CROSS REFERENCE TO RELATED APPLICATIONS

This application is a continuation of International Application No. PCT/US2019/062673, filed on Nov. 21, 2019, which claims the benefit of priority to U.S. Provisional Patent Application Nos. 62/770,620 and 62/770,624, both filed on Nov. 21, 2018 and titled “Unique Item Creation Using a Distributed Ledger.” International Application No. PCT/US2019/062673, filed on Nov. 21, 2019, is a continuation-in-part of International Application No. PCT/US2019/059389, filed on Nov. 1, 2019. Each of the above applications are incorporated herein by reference in their entirety.

### FIELD OF THE INVENTION

This disclosure is in the field of digital items. More specifically, the digital items have varying characteristics and are suitable for ownership, trading, and otherwise exchanging between owners. The digital items may relate to imaginary or fictional items. The digital items may also represent physical items existing in the real world and as such may be redeemed by an owner of the digital item for the physical item.

### SUMMARY OF THE INVENTION

The system and methods described herein provide for the generation, management, transferring, converting, and sharing of digital items based on distributed ledger or hash technology. In embodiments, the system creates a large set of dynamically generated items that may be unique and vary in rarity among the various items. In some embodiments, the system generates digital items that can be mapped to unique physical or digital items, though such mapping is not required in all embodiments of the system. The system provides an algorithmically secure way to ensure the rarity, immutability and ownership for each item in the item space of the large set of items. Digital items may be traded, gifted, or otherwise transferred between entities, and may be redeemed for a physical representation of the digital item. In some embodiments of the system, a distributed ledger may be utilized to securely track and verify ownership and transfer of an item.

### BRIEF DESCRIPTION OF THE DRAWINGS

FIG. 1 depicts an example block diagram showing a system for digital item creation using a distributed ledger, in an embodiment.

FIG. 2 depicts the smart contract of FIG. 1 in further example detail.

### DETAILED DESCRIPTION

In various embodiments, the inventive system is a decentralized application running on a peer-to-peer network of distributed servers that manage non-fungible token (NFT) generation. NFTs are generated by the system based on algorithms designed to provide a random distribution of characteristics. The characteristics of the items vary in various embodiments and implementations of the system. Some characteristics may be more desirable to users of the system based on the frequency with which they occur, visual attractiveness, etc. Some characteristics will occur more often and others very infrequently.

The system described herein may exist in various embodiments, which provide the required functionality in differing manners, using different types of computer hardware and executing different software modules. In addition to the various embodiments, each embodiment may be implemented by a user to create one or more item spaces with the requisite functionality to support the generation and transfer of the digital items, and management of the digital items with respect to physical real-world items. The concept of inventive system, embodiment, and implementation is similar to the difference between the concept of a word processor software, an actual software program created to serve as a word processor, and an installed word processor software program functioning on a computer processor.

In each implementation of an embodiment of the system, an item space is designed and defined by the implementor of the system. The item space definition determines the characteristics of the items in the item space, and how they are generated by the system. The system is designed such that items cannot be copied, forged or replicated except as allowed by the item space selected for each embodiment of the system. In some embodiments of the system, each item generated by each implementation of the system is unique within the item space of that implementation. In various embodiments, the system generates the digital items randomly within a statistical distribution defined by the item space and its design.

In various embodiments of the system, the item space lists in-real-world items, such as collectibles, shoes, cars, or flowers, or other physical items. The item space identifies digital characteristics of such real-world items, and allows the real-world item to be defined by a digital item including the unique characteristics of the real-world item.

In various embodiments of the system, item generation occurs through execution of a smart contract that receives a payment to a given blockchain address. Similarly, ownership or control of an item is transferred by execution of a smart contract. Item generation and transfer transactions are immutable and cannot be reversed.

### Distributed Ledgers

A distributed ledger system is a technology for securely documenting transactions between third parties. The ledger is “distributed” in the sense that it operates and is stored on processing systems controlled by multiple, unrelated, and independent third parties. Many distributed ledger systems utilize a “blockchain” technology to implement the distributed ledger in a secure manner. It should be understood that blockchain technology is only one way to implement a distributed ledger. In the description below, the terms distributed ledger and blockchain are used interchangeably.

The basis for blockchain technology is a linked list of data blocks. Each block contains data (which may or may not be encrypted) and a link to the prior block in the chain. In some implementations of a blockchain system, the data may include data structures such as those necessary to describe the digital items contemplated by the inventive system described herein, transaction data documenting the exchange of a digital currency, software such as an executable digital contracts (also referred to as Smart Contracts), and data associated with the use of a digital contract by specific parties, although it may also include other types of data as described in further detail below. The data in each block in the blockchain includes a hash of the previous block in the chain as a means of identifying and preventing attempts to modify prior blocks in the blockchain.

In many implementations of blockchain technology, the management and extension of the blockchain is decentralized and distributed over computer systems operated by numerous unaffiliated entities who contribute their computing power to the system. These distributed contributors provide the infrastructure of the blockchain system by storing copies of the blockchain, and performing the algorithms necessary to process transactions, deploy them into new blocks on the blockchain, and distribute those blocks to other parts of the system. An important aspect of blockchain security is that it is difficult to modify blocks after they have been added to the blockchain and accepted into the main branch, although blockchains do have temporary competing branches.

The data in the distributed ledger is sometimes freely available to any person who wants to access the data. Since many implementations of the distributed ledger technology utilize a public key/private key encryption technology, the entries in the distributed ledger may be reviewed by anyone using the public key data. However, a user cannot modify the recorded data such as to transfer ownership of the data or transfer a digital currency from that address without the private key.

### Smart Contracts

The blockchain technology has been enhanced by the concept of Smart Contracts. Smart Contracts are executable computer programs that are compiled into the data in a block in the blockchain by the developers of the Smart Contract. Once the Smart Contract has been deployed into the blockchain other users of the blockchain may execute the Smart Contract with confidence that it has not been modified by a malicious third-party. These executable computer programs are referred to as “Smart Contracts” because they may be used to represent and implement agreements between various parties regarding the transfer of digital currency and other types of assets, however, they do not have to represent contractual arrangements. A software developer develops the Smart Contract by writing program code using a scripting language such as JavaScript, Solidity, or other scripting languages, or an object coding language, such as Java, or a machine coding language such as C or C++.

When a Smart Contract is deployed into the blockchain, the program code is processed into a block by one of the contributors to the system just as any other transaction on the blockchain. The process of deploying the Smart Contract may include compiling the program code into bytecode, object code, binary code, or some other executable form. When the Smart Contract is successfully deployed into the block chain it is assigned an address in the same manner as any other blockchain transaction. This address is used to access the Smart Contract and execute the functionality provided in it. Typically, Application Binary Interface (ABI) information, similar to an application programming interface, is provided to a user of the contract, or the software that interfaces with the contract (such as a wallet application) so that the user can interact with the various functions of the Smart Contract. The ABI describes the various functions and methods provided as part of the Smart Contract so that they can be accessed by the user or the user's software.

A contract/program that has been deployed into the blockchain may then be used by anyone who has the address of the contract on the blockchain. In some embodiments of the system claimed herein, the Smart Contract may transfer payment in the form of cryptocurrency or other types of payment between parties in a contract, as well as generating or transferring ownership of a digital item, as well as initiation of conversion of the digital item into a physical real-world item, as will be described in more detail later. Executing the contract, or a portion of it, does not necessarily incur fees unless updates to the blockchain are required as part of that step in the contract. If the contract/program is properly implemented many different users may utilize the contract/program simultaneously to govern their own specific agreements or transactions.

The Smart Contract may have multiple steps that are executed or completed by different parties to the contract. For example, a contract/program may be invoked by a first party to make an offer to a second party or a group of potential contracting parties by instantiating a copy of a certain contract. The second party (or one of the group) may respond by “signing” that instance of the contract. The process of “signing” the contract may comprise invoking a programmatic method defined as part of the contract. Some contracts may provide for multiple parties, such as buyer, seller, lender, borrower, escrow agent, transfer agent, and others, all of whom may independently interact with a particular instance of a contract to sign it, or to take other actions associated with a specific type of contract.

Smart Contracts are well suited to contracts that involve digital assets or that may be completely executed via programmatic interactions between the contracting parties, the blockchain, digital assets, and resources on the internet or otherwise connected digitally to the contract. For example, Smart Contracts may be able to automatically transfer control and ownership of digital assets (such as cryptocurrency, or the created digital items discussed herein). The smart contracts may also be able to initiate transfer of money between PayPal or bank accounts via ACH or other electronic payment systems via transactions that are sent to third parties of the network, such as an oracle operated in conjunction with the PayPal or Bank account or other electronic payment system. Application programming interfaces provided by the external systems provide methods for a digital contract to execute actual transfers of assets or funds between parties without non-programmatic processes.

### Client Accounts/Digital Wallets

Distributed ledgers based on blockchain technology provide addresses for data that is recorded into the ledger, whether it be a Smart Contract, a cryptocurrency, or any other type of data stored in the ledger. As will be discussed in further detail below, data stored in a distributed ledger may include a digital asset such as an item generated by the system disclosed herein.

A person who owns or controls any data stored on a blockchain may store the addresses of the data in a client account that includes and/or is a digital wallet. The client account and/or digital wallet is a store of the private and public keys associated with data stored on the publicly available distributed ledger.

In some cases, these private and public keys are associated with a cryptocurrency. In such cases only the holder of the private key associated with the entry in the distributed ledger for the cryptocurrency may transfer a cryptocurrency to another address. Similarly, this same private/public key functionality may be used to control transfer of a digital item such as those described herein. The public key associated with the client account provides a publicly available address to which a digital item or cryptocurrency may be sent by another party using that party's private key.

Use of the public key/private key technology in combination with a distributed ledger assures that once the transfer of a digital item from one public key address to another and the transfer is encoded into a block in the blockchain of the ledger, it cannot be undone. If the private key associated with a public key address is lost, then the items associated with that public key address can never by transferred to another public key address. In the context of a cryptocurrency, the currency associated with the lost public key address is considered lost because it can never be spent without the private key. Similarly, a digital item associated with a public key address cannot be transferred to another public key address without access to the private key.

### Item Space Definition

Each embodiment of the system may be implemented many times on different processing systems by different implementors. Each implementation of an embodiment of the system uses the functions provided by the embodiment of the system to execute an implementation of a specific item space defined by the implementor.

The item space design includes a definition of characteristics for the items to be generated by a specific implementation of the system. The definition of a characteristic includes at least a name for the characteristic and a data type for the characteristic. The data type may be selected from any desired data type, such as integer number, decimal number, fixed or variable length character string, boolean, binary data (such as images), or other data types used in data processing applications. In some embodiments, an implementor may be able to define data types based on other underlying data types, such as enumerated lists of acceptable values, composite data types based on a combination of other data types which may include various primitive data types, used defined data objects, executable code in source or compiled format, or other types of data structures utilized in data processing applications.

An example of a list of characteristics for an implementation of the system is set forth in Table 1. In this example implementation of an embodiment of the system, each item has four characteristics, including an identifier (ID), a Type comprising a value selected from an enumerated list.

TABLE 1

| Characteristic | Data Type | Number of Values |
|---|---|---|
| ID | Integer | 21^{∧}64 − 1 (for a 64 bit integer) |
| Type | Enumerated List | Number of values in the list |
| Quality | Enumerated list | Number of values in the list |
| Style | image data (100 × 100 | 21^{∧}10,000 (black and white |
| | pixels) | image) |

The selection of characteristics and data types will determine the number of potential items in the item space since the number of potential items in the item space is equal to the number of unique combination of values for the characteristics. For example, an implementation using the characteristics in Table 1 may have 1000 different values for Type in the enumerated list for that characteristic. In example implementations, the Type data values may represent product identifications, such as types of weapons, types of vehicles, types of flowers, foods, sports cards, memorabilia, or any other consumer product. Using the example of flowers as a characteristic Type, the list of values for Type may comprise a list of the names of flower bouquets, such as various types of roses, lilies, carnations, snap dragons, or other varieties. Using the example of weapons as a characteristic Type, the list of values for Type may comprise a list of the names of weapons, such as various types of knives, guns, grenades, missiles, tanks, or other weapons. In the example of an implementation have a list of vehicles for the Type, the enumerated values may be a list of vehicle makes and models. In those examples, the Style characteristic may comprise an image of or relating to the flower bouquet, vehicle or weapon in the enumerated list.

TABLE 2

| Characteristic | Acceptable Values |
|---|---|
| ID | Any unique integer |
| Type | (“roses”, “lilies”, “snap dragons”, “carnations”, . . . ) |
| Quality | (“large”, “medium”, “small”, “vase”, |
| | “no vase” . . . ) |
| Style | (image corresponding to a particular Type) |

Assuming that the example in Table 2 has thousands of values for Type including different types of flowers, add-ons (such as balloons or cards), or other details of bouquet type, there are a large number of combinations for the Type, Quality, and Style characteristics, and millions of unique integers to associate with each of those combinations. If the example in Table 2 has thousands of values for a Type weapon including different calibers, manufacturers, or other details of weapon type, there are a large number of combinations for the Type, Quality, and Style characteristics, and millions of unique integers to associate with each of those combinations.

By selecting multiple characteristics having a large number of acceptable values, an implementation of the system may have a very large number of items in an item space, on the order of millions or billions. In some implementations, many of the items in the item space may be identical except for an ID characteristic assigned to the item for the purpose of preserving it as unique. For example, an implementation may be designed to generate many items having Type=“roses”, Quality=“small vased”, and the same data for Style, but with different ID values.

Another example of an item space definition is shown in Table 3. In this example the system is designed to generate digital items with characteristics similar to vehicles. Other systems may implement item definitions that are for characters in video games, planets, animals, professional athletes, etc.

TABLE 3

| Character- | | |
|---|---|---|
| istic | Data Type | Number of Values |
| ID | Integer | 2^{∧}64 − 1 (for a 64 bit |
| | | integer) |
| Type | (“car”, “truck”, “motorcycle”, | values in enumerated list |
| | “boat”, . . . ) | |
| Make | Names of vehicle manfacturers | values in enumerated list |
| Model | Model names for vehicles | values in enumerated list |
| Quality | Decimal number representing | Depends on decimal format |
| Style | quality image data (100 × 100 | 2^{∧}10,000 (black and white |
| | pixels) | image) |

Additionally, manufacturers of real-world physical items may store available items and the associated ID, Type, Make, Model, Quality, and Style in the Item Space such that other consumers may purchase or select available items to obtain a digital item representing the real-world physical item.

### Item Generation

When a user desires to obtain an item in the item space the user interacts with the system to cause a new item to be generated within the item space. The system generates unique items in an item space by executing an algorithm designed for each implementation. In some embodiments of the system, the item generation algorithm is executed in the context of a Smart Contract stored on a blockchain based digital ledger. In some embodiments, the Smart Contract requires a payment to a blockchain address referred to as the generation address. The amount of payment sent to the generation address may be fixed or variable, depending on the item space design. Once the Smart Contract confirms that the generation address has received the required payment, the Smart Contract creates an item based on the algorithm defined for the specific implementation of the system. In some implementations, a random combination of characteristics is selected from the items in the item space.

Once the Smart Contract has generated the item, it may send the item data to the person who purchased or otherwise caused the item to be generated by the system. The data comprising the digital item itself may be recorded into the distributed ledger and given an address like any other data on a blockchain structure. In some embodiments of the system, the item is delivered to the recipient by adding a transaction to a blockchain-based distributed ledger that incorporates the blockchain address of the digital item with the public key address of the recipient. In some cases, a separate transaction to the distributed ledger defining initial ownership is not required, such as if the owner's address is specified and recorded in the same transaction that records the generated digital item.

In some embodiments, certain values for a characteristic or combinations of values for a subset of characteristics may be more or less common in the items generated by the implementation of the system. This uneven distribution of probability in the selection of values for characteristics when generating a new item results in rarity of items with certain desirable characteristics. Items having other values for certain characteristics may be much more common.

Referring to the example of sports cards used above, an implementation of the system may be designed so that the value of a given Player A (such as Derek Jeter) for the Type is selected much less frequently during item generation than the value of other less-popular players, which may in turn be more common than “the Player A”. This uneven distribution of the frequency of characteristics creates rarity of items having a value for Type of “Player A”. Accordingly, an item with Type of a given more-popular player may be much less common than an item with Type equaling a less-popular player thus making the former item more rare and more desirable than the latter. For example, an implementation may be designed to generate many items having Type=“Derek Jeter”, Quality=“3rd year”, and the same data for Style, but with different ID values. As an additional example, the same implementation may generate more items with the combination of values Type=“Derek Jeter” with Style equal to a bitmap image of a Derek Jeter's rookie year as compared to the number of items that implementation generates with Type=“Derek Jeter” and Style equal to an image of a Derek Jeter during his 5th year in the Major Leagues. The scarcity of items having certain rare, desirable characteristics creates an implied value for an item based on the likelihood of generation of an item with that characteristics.

Accordingly, the smart contract may include an item creation algorithm that generates certain values for a characteristic or combinations of values for a subset of characteristics that are then mapped onto a category or a pool of existing items (digital or physical real-world items). This creation algorithm is not complete until an item is consumed from such pool and it is associated with the a newly minted token held by the owner of the item. This creation method allows the item space to map certain rarity characteristics achieved by a weighting algorithm in the smart contract (e.g., the creation algorithm) onto an existing list of items matching such certain characteristics and to facilitate tokenization of such items by association with generated token that is then owned by the recipient of such token. For example, a pool of digital tokens can be created that represents an “A Players” category containing a list of cards representing “A Players” such as Derek Jeter during his 5^{th} year in the Major Leagues. The creation algorithm within the smart contract can have weighted distribution of characteristics that if generated map onto a certain player in the “A Player” category triggers a selection of Derek Jeter during his 5^{th} year in the Major Leagues card to be assigned to the new token and owned by the recipient of such token.

### Item Transactions

In various embodiments and implementations of the inventive system, different technologies may be utilized to store, exchange, and secure the items generated by the system. These technologies may range from simple file storage of a file to system of storage and exchange managed by a third-party. As described above, in some embodiments of the system, a public-private key technology is utilized to identify and secure a “client account” (or “wallet”) to associate the digital items with as they are generated by the system. The generated digital items are then accessible by the associated client account using a private key that allows the owning client to generate transactions for that client account and associated digital item.

Digital items that are stored on the blockchain may only be transferred to a new owner by inserting another record into the distributed ledger of the blockchain. This entry requires the private key of the current owner of the digital item to initiate the transfer. A new entry may be recorded into the blockchain will provide the address of the digital item and the public key address of the new owner.

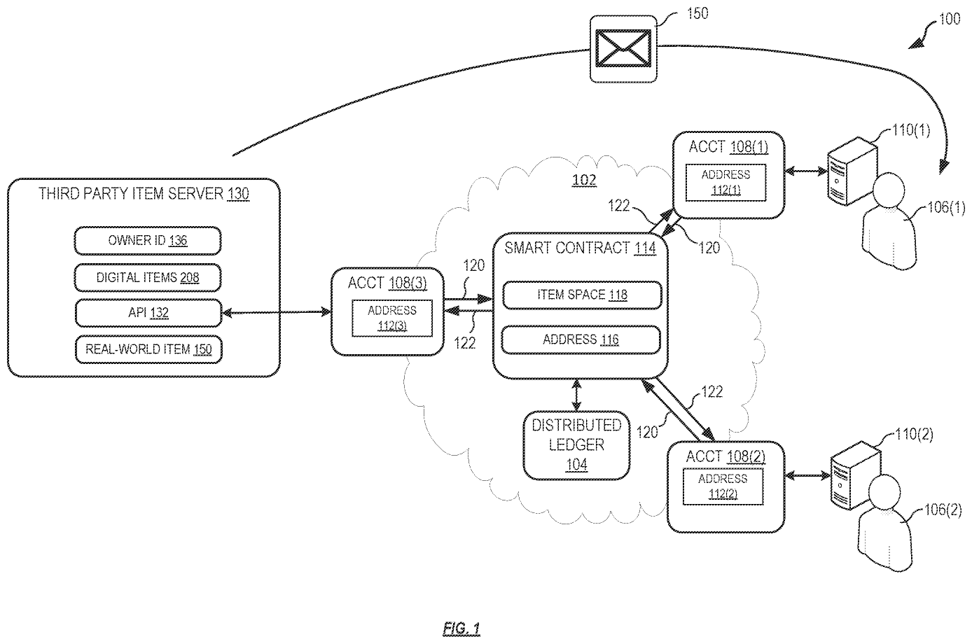

FIG. 1 depicts an example block diagram showing a system 100 for digital item creation and initiation of obtaining a real-world physical item using a distributed ledger, in an embodiment. System 100 facilitates item generation and item transaction between users for items generated in an item space according to the above discussed concepts of a “item generation,” “item transaction,” and “item space”. When instructed to do so, system 100 also initiates obtaining, by a given user, a real-world physical item represented by the digital item.

System 100 includes network 102 formed from a plurality of nodes that process transactions and store transaction information in a distributed ledger 104. Distributed ledger 104 is, for example, a blockchain as discussed above. Other formats of distributed ledgers 104 may be implemented as well, such as a directed acyclic graph. Although FIG. 1 only shows one distributed ledger 104, it should be understood that a copy of distributed ledger 104 is distributed to each (or at least a plurality of) the nodes within the network 102, and that the nodes work to add blocks to distributed ledger 104 such that each node stores an identical copy of distributed ledger 104. Network 102 may verify the distributed ledger 104, such as to create new blocks in the blockchain using any type of consensus, including proof-of-work, proof-of-stake, and/or a voting system.

Network 102 is accessible to users 106 via one or more client accounts 108 (which may be and/or include a digital wallet). The client account 108(1) is owned/operated by user 106(1) and is accessed by user 106(1) using device 110(1). The client account 108(2) is owned/operated by user 106(2) and is accessed by user 106(2) using device 110(2). Devices 110 may be any computing device configured to interface with a respective user 106 and the network 102, such as a laptop, desktop computer, tablet, smartphone, smartwatch, etc. Each client account 108 has a unique address 112 that identifies that account on network 102. Each device 110 also stores one or more private keys to access and control one or more corresponding client account 108 and transfer and/or receive data associated therewith.

Network 102 may also include one or more smart contracts 114, of which only one smart contract 114 is shown in FIG. 1. Each smart contract 114 may include a unique address 116 that identifies that contract on network 102. The smart contract 114 may be distributed with the distributed ledger 104 to each of the nodes on the network 102. The smart contract 114 may be an implementor that implements an item space 118 therein. Each client account 110 interacts with smart contract 114 by sending a corresponding transaction 120. Smart contract 114 is, for example, a script that executes in response to receiving one of transactions 120. The received transaction 120 contains data that determines execution behavior of smart contract 114, as described in more detail below. Smart contract 114 may send one or more outputs 122 to one or more of client accounts 108 as part of its execution.

The transactions 120 generated with respect to the smart contract 114 operate on the smart contract 114 to perform a variety of functions (as indicated by the constraints of the smart contract 114). For example, a user 106(1) may interact with account 108(1) to generate a transaction 120 that causes the smart contract 114 to create a digital item. As another example, a third party operating a third-party item server 130 may interact with account 108(3) (directly or via the third party item server 130) to generate a transaction 120 that causes the smart contract 114 to create a digital item that has characteristics representing a real-world physical item 150 that is either currently present in the real-world, or capable of generation in the real-world. The generated digital items are then recorded into the distributed ledger 104 and transmitted to all nodes of network 102 in the next distribution of the distributed ledger 104 thereby creating an immutable record of the generated digital items and their associated characteristics. As another example, a user 106(1) may interact with account 108(1) to generate a transaction 120 that causes the smart contract 114 to transfer ownership (either via gift, trade, exchange, a sale, or the like) of digital item(s) to user 106(2). This ownership transfer 106(2) is then recorded into the distributed ledger 104 and transmitted to all nodes of network 102 in the next distribution of the distributed ledger 104 thereby creating an immutable record of the transaction between owners 106(2) and 106(1).

As another example, a user 106(1) may interact with account 108(1) to generate a transaction 120 that causes the smart contract 114 to interact with a third-party server 130 (via transmission of another transaction from the smart contract 114 to account 108(3) operated by or in association with the third-party item server 130) and initiate conversion of the digital item into a real-world physical item 150. If the real-world physical item 150 is not already present in the real world, a new real-world physical item 150 may be created. A real-world physical item 150 having the characteristics of the digital item 208 defined in the transaction 120 initiating conversion of the digital item into a real-world item 150 may then be delivered (via mail, FedEx, UPS, etc.) to the owner 106(1) (or another party when so indicated in the transaction 120) generated by the owner 106(1) and account 108(1).

The third-party server 130 may interface with client account 108(3) via an application program interface (API) 132. In one example, the third-party item server 130 is associated with a manufacturer that is capable of creating (or has previously created) a real-world physical item 150 representing one or more digital items 208. In an example, the API 132 is an HTTP service layer. It should be appreciated that the API 132 may be implemented using other service protocols without departing from the scope hereof. In certain embodiments, the API 132 uses SSL encryption (HTTPS) to secure the connection between the network 102 and the to the third-party item server 130. Accordingly, the third-party item server 130, via the API 132, may communicate with the network 102 to obtain information in the distributed ledger 104 that is utilized to initiate and send real-world physical items 150 to defined recipients.

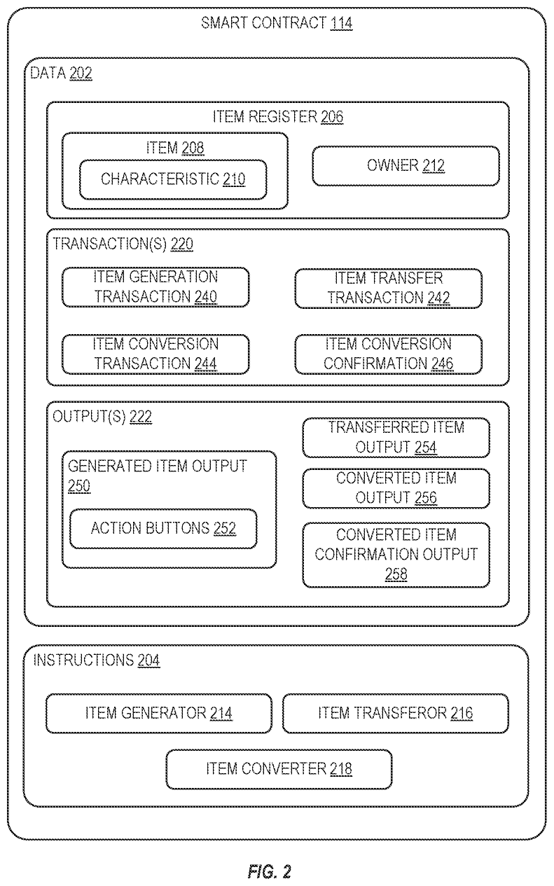

FIG. 2 depicts the smart contract 114 of FIG. 1 in further example detail. Smart contract 114 includes associated data 202 and instructions 204. Data 202 includes an item register 206 including a list of items 208 having given characteristics 210, and associated owner 212 having rights to the given item 208. The owner list 212 may identify the address (e.g., address 112 in FIG. 1) of the client account (e.g. client account 108 in FIG. 1) of the user (e.g., user 106 in FIG. 1) that owns rights to the given item 208. Item register 206 is an example of all or at least part of item space 118 of FIG. 1. Data 202 may further include transactions 220 received at the smart contract 114 and outputs 222 transmitted from the smart contract 114. The transactions 220 may be a single transaction or multiple individual transactions that are examples of one or more of the transactions 120 shown in FIG. 1. The outputs 222 may be a single output or multiple individual outputs that are examples of one or more of the outputs 122. Transactions 220 and outputs 222 may initiate or be initiated by one or more of the instructions 204 discussed below.

Instructions 204 may include an item generator 214. Item generator 214 may operate to generate one or more digital items 208 and the associated characteristics 210. In one implementation, smart contract 114 receives from a client account 108 item generation transaction 240 indicating that user 106 desires to obtain an item. Item generation transaction 240 may indicate a particular item that the user 106 desires to obtain, and associated variables such as any one or more of owner (e.g., the user 106, or another user if the user 106 is gifting or obtaining the item on their behalf), characteristics of the item (such as color, size, style, etc.), rarity variables indicating options selected by the user 106 to increase rarity values, and other information used to determine the exact item generated. Item generator 214 is then initiated to generate and store an item 208 having certain characteristics 210 and assign the rights to that specific item to the requesting user 106 as the owner 212 (or another user 106 if the transaction 240 indicates such).

The generated item 208 may be an in-real-world item (e.g., an item created in response to a transaction 240 received that defines characteristics 210 representing characteristics of an actual item already present in the real world), or may be a unique item generated by item generator 214 executing an algorithm designed for each implementation of item generation. The algorithm used by the item generator 214 to generate the item 208 may include variables set by the user 106 (or third party, such as a manufacturer, via third party item server 130) as defined by the item generation transaction 240 received that initiates the item generator 214. For example, the item generation transaction 240 may indicate that the user 106 desires a rare item, and has accordingly released more value (e.g., cryptocurrency, tokens, etc.). In such example, the algorithm used by the item generator 214 may include weights that guarantee or make it more likely that the generated item 208 will have a higher rarity. Additionally, as another example, all or some of the item characteristics 210 may be generated at random by the item generator 214.

As another example of item generation by item generator 214, all of the item characteristics 210 may be defined within the item generation transaction 240, such as where the digital item 208 generated by the item generator 214 represents an in-real-world item and is defined by characteristics 210 matching some or all of the characteristics of the in-real-world item. In some embodiments, the item generator 214 is not initiated unless the smart contract 114 receives an item generation transaction 240 indicating payment from the requesting user to a generation address. For example, referring to FIG. 1, the requesting user may be user 106(1), and the generation address is the address 112(3), where the generated digital item 208 is capable of conversion into a real-world physical item 150 if so desired by the owner of the generated digital item 208. In some embodiments, item generator 214 may generate a digital item 208 that corresponds to an already present in-real-world physical item 150. In some embodiments, the digital item 208 generated by item generator 214 does not have a corresponding in-real-world physical item 150 at the time of generation of the digital item 208. In such embodiments, the in-real-world physical item 150 is generated by the third party operating third party item server 130 after initiation of item converter 218, discussed below. The amount of payment sent to the generation address may be fixed or variable, depending on the item space design.

The item generator 214 may also combine multiple digital items 208 to create a new digital item (or real-world physical item 150) that is a combination thereof. For example, an item generation transaction 240 may indicate to combine a first digital item with a second digital item to generate a new digital item. For example, one user 106 may own two digital items 208, one representing a bouquet or 12 red roses and another representing a bouquet of 12 pink roses. The owner 106 may generate an item generation transaction 240 indicating to combine each of the two digital items into a single item having characteristics of a bouquet of 24 red and pink roses.

Upon generation of the digital item 208, the item generator 214 may generate a generated item output 250. The generated item output 250 may be a message that is transmitted to the owner of the digital item 208, and the third-party 130 capable of converting the digital item 208 into a real-world physical item 150. The generated item output 250 may further be recorded into the distributed ledger 104 to create an immutable record thereof. Generated item output 250 provides many advantages over conventional e-commerce methods. First, the owner of the digital item 208 has knowledge of its receipt and can utilize the digital item 208 even without having the real-world physical item 150 version thereof. Upon receipt of the generated item output 250, the owner of the associated digital item 208 can sell the digital item 208, they can trade digital item 208 for another digital item without dealing with packaging it and shipping it. In certain embodiments, the owner can gift digital item 208 to another person—by forwarding the generated item output 250 to another person (or by generating an item transfer transaction 242 discussed below). The recipient can then open the forwarded message and view the digital item 208. For example, where the digital item 208 is a bouquet of flowers, the generated item output 250 may include a 3-dimensional image of the bouquet such that the owner may promote it on social media. When the recipient desires, the recipient can trade the digital item 208 for some other digital item, sell the digital item 208, or convert the digital item 208 into a real-world physical item 150.

Accordingly, the generated item output 250 may include a variety of action buttons 252 that are displayed on a client device of the owner of the digital item 208. Alternatively, the action buttons 252 may be generated at a client device of the owner of the digital item 208 upon receipt of the generated item output 250. Such action buttons 252 include a “transfer item button”, “deliver button”. The action buttons 252 may automatically create additional transactions 220 (e.g., transactions 120) that implement functions of the smart contract 114. For example, where the action button 252 includes a transfer item button, an item transfer transaction 242 (discussed in further detail below) may be transmitted to the smart contract 114. As another example, where the action button 252 includes a “deliver button”, an item conversion transaction 244 (discussed in further detail below) may be generated and transmitted to the smart contract 114.

Instructions 204 may further include an item transferor 216. The item transferor 216 may transfer ownership rights between one or more users. For example, the smart contract 114 may receive an item transfer transaction 242 from the accounts 108(1) indicating that user 106(1) desires to transfer the generated item 208 from user 106(1) to user 106(2). In response, the item transferor 216 may update the owner 212 of the transferred item 208. The item transferor 216 may then generate an item transfer output 254 which is recorded on the distributed ledger 104 and distributed to all nodes of the network 102 upon the next distribution of the distributed ledger 104. The item transfer output 254 may also generate an alert (e.g., an SMS message or other prompt) displayed on the client devices associated with the accounts 108 of the parties (e.g., users 106) associated with the transfer implemented in response to item transfer transaction 242.

The item transferor 216 may also interface with a third party associated with the generated item 208. For example, referring to FIG. 1, a digital item server 130 may interface with client account 108 via an application program interface (API) 132. In one example, the digital item server 130 is associated with a game that allows players to change skins associated with the virtual objects or persons within the game, and each generated item 208 is a skin in the game. In an example, the API 132 is an HTTP service layer. The API 132 may provide all the needed endpoints to generate, distribute, transfer, etc. items (e.g., items 208) between the game servers and players. The API 132 may also handle authentication of the user and game servers. In certain embodiments, the API 132 uses SSL encryption (HTTPS) to secure the connection between the network 102 and the to the digital item server 130 (e.g., a game server). Accordingly, the digital item server 130, via the API 132, may communicate with the network 102 to obtain information in the distributed ledger 104 that is utilized to define items shown in a game hosted by the digital item server 130.

Upon generation of the item 208 by the item generator 214 (and, in some embodiments, receipt of a transaction 122 from the owning user 106 indicating to use the generated item 208 in the game associated with the digital item server 130), the item transferor 216 may transmit the item 208 to the address 112(3) of the client account 108(3). In response, the API 132 analyzes the received item and allows the item to be used in the virtual world hosted by the digital item server 130. In some embodiments, each user 106 is required to enter their associated owner ID 136 in order to obtain a client account 108 and utilize one or more of network 102, distributed ledger 104, and smart contract 114.

Instructions 204 may further include an item converter 218. Item converter 218 interfaces with the network 102 and the third-party server 130 to initiate conversion of the digital item 208 into a real-world physical item 150. The item converter 218 may commence upon receipt of an item conversion transaction 244 received from an account 108 indicating to convert the digital item 208 into a real-world physical item 150. Such item conversion transaction 244 may include delivery information (such as time, address, recipient). Item converter 218 generates a converted item output 256 that is transmitted to the third-party item server 130 (e.g., via account 108(3) at address 112(3). Accordingly, the converted item output 256 may initiate the third-party item server 130, or the manufacturer associated therewith, to deliver a real-world physical item 150 representing the digital item 208 associated with the item conversion transaction 244. In certain embodiments, upon confirmation that the real-world physical item 150 is capable of being obtained by the manufacturer associated with the third-party server 130, the third-party server 130 may transmit (via account 108(3)) an item conversion confirmation 246 to the smart contract 114. In response to receipt of the item conversion confirmation 246, the item converter 218 may generate a converted item confirmation output 258 that is transmitted to the recipient of the real-world physical item 150. The converted item confirmation output 258 may include tracking information and delivery information of the real-world physical item 150.

The discussion herein includes the terms “transmit” and “receive”. These terms may include transmitting data, or data packets, directly from one entity or device to another. Alternatively or additionally, these terms include recording a line-item on a distributed ledger, and then the receiving or transmitting entity/device parsing through the distributed ledger to identify data items in the distributed ledger assigned thereto.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

1. A method of digital item management using a distributed ledger comprising:
deploying a smart contract that implements an item space;
receiving, by the smart contract, a transaction from a client account for managing digital items, the transaction requesting an action on a digital item in the item space;
executing at least a portion of the smart contract to cause the action requested by the transaction;
transmitting, by the smart contract, an output to the client account regarding the transaction.

2. The method of claim 1 wherein the transaction is an item generation transaction.

3. The method of claim 2, wherein the smart contract generates a digital item in response to the item generation transaction and records it into the distributed ledger.

4. The method of claim 2, wherein the item generation transaction further comprises one or more variables indicating information used to generate a digital item.

5. The method of claim 2, wherein the generated digital item represents an actual item already present in the real world or a unique item generated in accordance with an algorithm.

6. The method of claim 2, wherein the item generation transaction is from a client account associated with a third-party server, and the item generation transaction causes the smart contract to create a digital item that has characteristics representing a real-world physical item that is either currently present in the real-world, or capable of generation in the real-world.

7. The method of claim 2, wherein the item generation transaction is from a client account associated with a third-party server, and the item generation transaction causes the smart contract to create a digital item that is a virtual object for use in a game associated with the third-party server.

8. The method of claim 1 wherein the transaction is an item transfer transaction.

9. The method of claim 8 wherein the smart contract transfers ownership of an item to a different client account in response to the item transfer transaction and records the new ownership into the distributed ledger.

10. The method of claim 1 wherein the transaction is an item conversation transaction.

11. The method of claim 10 wherein the smart contract converts the digital item to a real-world physical item in response to the item conversation transaction.

12. The method of claim 1, wherein the item space defines one or more characteristics of digital items, wherein a characteristic further comprises a name and a datatype.

13. The method of claim 12, wherein a datatype further comprises a list of possible values for the characteristic.

14. An apparatus comprising a non-volatile machine-readable medium storing a program having instructions which when executed by a processor will cause the processor to perform a method of digital item management using a distributed ledger, the instructions of the program for:
deploying a smart contract that comprises an implementor that implements an item space;
receiving, by the smart contract, a transaction from a client account for managing digital items, the transaction requesting an action on a digital item;
executing at least a portion of the smart contract to cause the action requested by the transaction;
transmitting, by the smart contract, an output to the client account regarding the transaction.

15. The apparatus of claim 1 wherein the transaction is an item generation transaction.

16. The apparatus of claim 15, wherein the smart contract generates a digital item in response to the item generation transaction and records it into the distributed ledger.

17. The apparatus of claim 1 wherein the transaction is an item transfer transaction.

18. The apparatus of claim 17 wherein the smart contract transfers ownership of an item to a different client account in response to the item transfer transaction and records the new ownership into the distributed ledger.

19. The apparatus of claim 1 wherein the transaction is an item conversation transaction.

20. The apparatus of claim 19 wherein the smart contract converts the digital item to a real-world physical item in response to the item conversation transaction.
